(19) United States
(12) Patent Application Publication
(10) Pub. No.: US 2008/0094191 A1
(43) Pub. Date: Apr. 24, 2008

(54) Display Device for Displaying a Theft Attempt and Method for Operating Said Device

(75) Inventors: Helmut GRICKSCHEIT, Herrenberg (DE); Dirk Hassert, Wangen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/662,058

(22) PCT Filed: Aug. 27, 2005
(86) PCT No.: PCT/EP05/09277

§ 371 Date: Dec. 13, 2007

(30) Foreign Application Priority Data
Sep. 8, 2004 (DE) 10 2004 043 336.4

(51) Int. Cl. B60R 25/00

(52) U.S. Cl. 340/426.34

(57) ABSTRACT

In an indicator device for indicating an attempted theft of objects which are detachably fixed to a vehicle, at least one piezoelectric sensor is arranged in a recess between the vehicle and the object and is placed under pressure in an installation position of the object to be secured. In addition, a method for operating an indicator device for indicating an attempted theft of detachably fixed objects is proposed, in which method the piezoelectric sensor is kept under pressure. When the object is removed from the recess, the pressure acting on the piezoelectric sensor changes, as a result of which a transmission antenna which is connected to the sensor emits a signal in order to activate an alarm system.

### BACKGROUND AND SUMMARY OF THE INVENTION

This invention relates to an indicator device for indicating an attempted theft and a method for operating an indicator device.

In order to protect high-value objects, such as for example, vehicle wheel rims, against theft, mechanical vehicle rim locks which can only be opened by means of special keys are generally used. These locks can however easily be broken open with a commercially available tool and the keys easily copied so that this device cannot provide sufficient protection against removal without permission. Furthermore, with the conventional device there is no indication of the attempted theft by a vehicle alarm system. A thief can thus wander around unimpeded without his intentions being thwarted by a visual or audible signal.

In addition, encoded wheel screws are known which, however, do not provide any better protection against an attempted theft.

Moreover, systems for an electronic wheel protector and tow-away preventer which are composed of a position sensor and an electronic evaluation system are known. When the vehicle is parked on a level or sloping surface, its position is programmed in as the zero position when the alarm system is switched on. A transgression of defined limiting values in terms of position and speed of change then triggers an alarm. However, normal position changes such as, for example, air loss in the tires, intentional rocking of the vehicle or an underlying surface which is becoming soft can trigger an alarm if they are not detected by the electronic system.

German laid-open patent application US 2004/0056763 A1 discloses a device for providing antitheft protection for vehicle wheel rims in which a coil is arranged in the region of a vehicle wheel. Said coil is monitored for certain parameters such as, for example, the inductance of the coil as a function of the metal content of the rim or the reactance. As soon as one of the parameters changes, an alarm is triggered. In order to reduce the relatively high quiescent current consumption it is proposed to interrogate the individual parameters only at certain time intervals. A connection to another device for providing antitheft protection such as, for example, a proximity sensor, or the provision of a separate proximity sensor, is also proposed. However, this makes the device and the method implemented with it relatively complex.

The invention is based on the object of specifying a reliable, improved and simplified indicator device for indicating an attempted theft of objects which are detachably fixed to a vehicle, and a method for operating an indicator device which consumes as little energy as possible.

The object is achieved according to the invention by means of features claimed.

Advantageous embodiments and advantages of the invention can be found in the description and are also claimed.

In the indicator device according to the invention, at least one piezoelectric sensor is arranged in a recess between a vehicle and an object which is detachably fixed thereto and is placed under pressure in an installation position of the object. The piezoelectric sensor is preferably arranged in a wheel recess in order to indicate an attempted theft of a vehicle wheel rim or of a wheel. This recess can also be a recess for a spare wheel which is accessible from the outside, such as are provided, for example, on offroad vehicles. It is also possible to provide for the piezoelectric sensor to be arranged in a recess for a roofrack, bicycle rack or some other high-value object which needs to be secured.

The piezoelectric sensor is expediently coupled to an alarm system. In this context, the piezoelectric sensor is preferably connected to a transmission antenna via a circuit. In a vehicle wheel rim antitheft protection means the transmission antenna is expediently arranged in the region of a wheel hub.

In one installation position of the object to be secured, the piezoelectric sensor can advantageously be placed under mechanical pressure by a spring, for example a leaf spring or a helical spring. The pressure acting on the piezoelectric sensor can also be generated by a device with a similar effect such as, for example, an elastomer element, for example a rubber part. The piezoelectric sensor can also be arranged in an elastomer sheath in order to protect it against contamination. If the pressure acting on the piezoelectric sensor decreases, for example when the object to be secured is removed without permission, the piezoelectric sensor expands and generates an electric voltage owing to the known, piezoelectric effect. This can advantageously be used to excite the connected transmission antenna to transmit a pulse. This pulse can be received by a receiver antenna which is advantageously arranged inside the vehicle. As a result, an alarm device of the vehicle which outputs a warning signal can be activated. It is possible here to trigger, for example, intermittent sound signals and/or flashing visual signals. As a result, as is known, attention is excited and the potential misappropriator can be prevented from continuing his attempted theft. It is particularly advantageous here that an alarm system which is already present in any case in the vehicle can be utilized. There is thus no need to install an additional alarm device. Moreover, using the piezoelectric sensor to generate signals allows the receiver antenna to be embodied with a passive design, as a result of which there is no quiescent current consumption by the sensor.

According to one method for operating an indicator device according to the invention, at least one piezoelectric sensor which is arranged in a recess between a vehicle and an object to be secured, for example a vehicle wheel rim, is placed under pressure in an installation position of the object. When the object is removed from the recess, the pressure acting on the piezoelectric sensor changes, as a result of which a transmission antenna which is connected to the sensor emits a signal in order to activate an alarm system.

In the text which follows, the invention will be explained in more detail by means of an exemplary embodiment described in the drawings. The drawings, the description and the claims contain numerous features in combination which a person skilled in the art would also expediently consider individually and combine to form further appropriate combinations.

### BRIEF DESCRIPTION OF THE DRAWINGS

FIG. 1 is a schematic illustration of an embodiment of an indicator device according to the invention in a wheel recess;

FIG. 2 is a detailed view according to FIG. 1 in section; and

FIG. 3 is a schematic illustration of the indicator device according to the invention in the state in which an object to be secured is removed.

### DETAILED DESCRIPTION OF THE INVENTION

Identical elements, or elements which remain substantially the same, are provided with the same reference symbols in the figures.

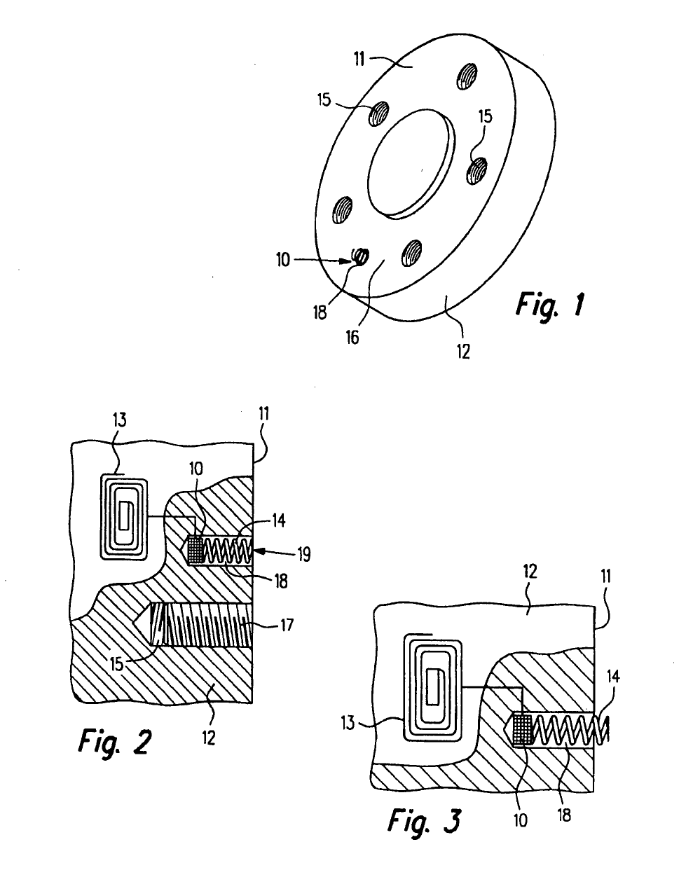

FIG. 1 is a schematic illustration of an exemplary embodiment of an indicator device according to the invention in a preferred wheel recess which serves to secure a mounted vehicle wheel against an attempted theft. In one end side 11 of a wheel rack 12, threaded bores 15 are arranged which serve to hold wheel screws (not shown) with which a wheel (not illustrated) is fixed to the wheel rack 12. For the sake of simplicity, only some of the threaded bores 15 are provided with a reference symbol. In its installation position, the wheel faces the end side 11 of the wheel rack 12. In a region 16 lying between two threaded bores 15, a bore 18 is arranged in which a piezoelectric sensor 10 is located. The piezoelectric sensor 10 which is arranged in the bore 18 is connected to an alarm system (not shown). In the unmounted state, the piezoelectric sensor 10 is relieved of loading, while when the wheel is mounted the sensor 10 can be placed under pressure. In the unmounted state, the spring 14 protrudes beyond the end side 11 of the wheel rack 12, as is apparent from the illustration in FIG. 3.

In FIG. 2, the region 16 from FIG. 1 is illustrated in section with a wheel rack 12, with a threaded bore 15 into which a wheel screw 17 is screwed, and a bore 18 in which a piezoelectric sensor 10 is arranged. The piezoelectric sensor 10 is connected via a circuit to a transmission antenna 13 which is arranged in the region of a wheel hub (not illustrated in more detail). A receiver antenna which is connected to the transmission antenna 13 and which is not shown in the figures is arranged inside the vehicle.

The vehicle wheel rim to be secured or the wheel to be secured is in the installation position in FIG. 2 and is not shown. In the installation position, the piezoelectric sensor 10 is placed under mechanical pressure. This is done by means of a spring 14 which is embodied as a helical spring. The latter is located between the piezoelectric sensor 10 and a free end 19 of the bore 18 and is compressed in an installation position of the vehicle wheel rim to be secured. In the installation position, the vehicle wheel rim (not shown) exerts a pressure on the spring 14, which pressure acts on the piezoelectric sensor 10 and keeps it under pressure in the installation position.

When the vehicle wheel rim or the wheel is removed from the wheel rack 12, the spring 14 is relieved of loading, as a result of which the pressure acting on the piezoelectric sensor 10 is reduced. The electric voltage which is generated in the process causes the transmission antenna which is connected to the sensor 10 to receive a pulse and to emit a signal to activate an alarm system.

FIG. 3 shows the state of the indicator device according to the invention during or after the removal of the vehicle wheel rim, in which case the spring 14 expands and the pressure on the piezoelectric sensor 10 thus decreases. Owing to the known piezoelectric effect, the sensor 10 generates an alternating voltage which excites the connected transmission antenna 13 to transmit a pulse or a data telegram which is received by the receiver antenna. As a result, an alarm system is activated and a visual and/or acoustic alarm is triggered, as a result of which a possible attempted theft can be prevented.

Using the piezoelectric transmitter allows the receiver antenna arranged in the vehicle to be embodied with a passive design, as a result of which there is advantageously no consumption of quiescent current.

The indicator device according to the invention and the method for operating the indicator device can also be used with spare wheels which are accessible from the outside, for example on offroad vehicles, or for other objects to be secured, for example for roofracks, cycle racks or the like.

1-10. (canceled)

11. An indicator device for indicating an attempted theft of an object which is detachably fixed to a vehicle, comprising at least one piezoelectric sensor arranged in a recess between the vehicle and the object and placed under pressure in an installation position of the object.

12. The indicator device as claimed in claim 11, further comprising a transmission antenna to which the piezoelectric sensor is connected via a circuit.

13. The indicator device as claimed in claim 11, wherein a receiver antenna is arranged inside the vehicle.

14. The indicator device as claimed in claim 11, wherein the piezoelectric sensor is coupled to an alarm system.

15. The indicator device as claimed in claim 11, wherein the piezoelectric sensor is placed under pressure by a spring, an elastomer, or a spring and an elastomer.

16. The indicator device as claimed in claim 11, wherein the piezoelectric sensor is arranged in a wheel recess.

17. The indicator device as claimed in claim 12, wherein the transmission antenna is arranged in the region of a wheel hub.

18. The indicator device as claimed in claim 12, wherein a receiver antenna is arranged inside the vehicle.

19. The indicator device as claimed in claim 12, wherein the piezoelectric sensor is coupled to an alarm system.

20. The indicator device as claimed in claim 13, wherein the piezoelectric sensor is coupled to an alarm system.

21. The indicator device as claimed in claim 12, wherein the piezoelectric sensor is placed under pressure by a spring, an elastomer, or a spring and an elastomer.

22. The indicator device as claimed in claim 13, wherein the piezoelectric sensor is placed under pressure by a spring, an elastomer, or a spring and an elastomer.

23. The indicator device as claimed in claim 14, wherein the piezoelectric sensor is placed under pressure by a spring, an elastomer, or a spring and an elastomer.

24. The indicator device as claimed in claim 12, wherein the piezoelectric sensor is arranged in a wheel recess.

25. The indicator device as claimed in claim 13, wherein the piezoelectric sensor is arranged in a wheel recess.

26. The indicator device as claimed in claim 14, wherein the piezoelectric sensor is arranged in a wheel recess.

27. The indicator device as claimed in claim 15, wherein the piezoelectric sensor is arranged in a wheel recess.

28. A method for operating an indicator device for indicating an attempted theft of a detachably fixed object, comprising placing at least one piezoelectric sensor, which is arranged in a recess between a vehicle and the object, under pressure in an installation position of the object.

29. The method as claimed in claim 28, wherein, when the object is removed from the recess, the pressure acting on the piezoelectric sensor changes, as a result of which a transmission antenna, which is connected to the sensor, emits a signal in order to activate an alarm system.

30. The method as claimed in claim 29, wherein the alarm system is activated when a vehicle wheel is removed from a wheel recess.
